(19) United States
(12) Patent Application Publication
(10) Pub. No.: US 2004/0067315 A1
(43) Pub. Date: Apr. 8, 2004

(54) Two-component systems for producing elastic coatings

(76) Inventors: Meike Niesten, Koln (DE); Lutz Schmalstieg, Koln (DE); Joachim Simon, Dusseldorf (DE)

Correspondence Address: BAYER POLYMERS LLC, 100 BAYER ROAD, PITTSBURGH, PA, 15205, US

(21) Appl. No.: 10/678,492

(22) Filed: Oct. 3, 2003

(30) Foreign Application Priority Data
Oct. 7, 2002 (DE) 10246708.0

(51) Int. Cl. B05D 3/02

(52) U.S. Cl. 427/372.2; 427/384; 528/60; 528/61

(57) ABSTRACT

The present invention relates to two-component coating systems with extended pot life for producing elastic coatings. The coating systems comprise polyurethane prepolymers based on polyether polyols prepared in the presence of double metal cyanide (DMC) catalysts and also comprise amino-functional polyaspartic ester curing agents.

### CROSS REFERENCE TO RELATED PATENT APPLICATION

The present patent application claims the right of priority under 35 U.S.C. § 119 (a)-(d) of German Patent Application No. 10246708.0 filed Oct. 7, 2002.

### FIELD OF THE INVENTION

The present invention relates to two-component coating systems with extended pot life for producing elastic coatings. The coating systems comprise polyurethane prepolymers based on polyether polyols prepared in the presence of double metal cyanide (DMC) catalysts and also comprise amino-functional polyaspartic ester curing agents.

### BACKGROUND OF THE INVENTION

Two-component coating systems based on polyurethane or polyurea are known and are employed in the art. In general they comprise a liquid polyisocyanate component and a liquid isocyanate-reactive component. Reaction of polyisocyanates with amines as an isocyanate-reactive component produces highly crosslinked, solvent-free polyurea coatings. Primary amines and isocyanates, however, generally react with one another very rapidly. Typical pot lives or gel times often amount to just several seconds to a few minutes. Consequently such polyurea coatings cannot be applied manually but instead only with special spraying apparatus. Such coatings nevertheless possess excellent physical properties.

The reaction between polyisocyanates and amines can be retarded by using secondary amines. EP-A 403 921 and U.S. Pat. No. 5,126,170 disclose the formation of polyurea coatings by reaction of polyaspartic esters with polyisocyanates. Polyaspartic esters possess a low viscosity and a reduced reactivity towards polyisocyanates and can therefore be used to prepare solvent-free coating compositions having extended pot lives. In many cases, however, the pot lives still prove to be too short for industrial usefulness, particularly for manual application. Moreover, the usefulness of these systems is limited by their mechanical properties.

There is an established need in the art for coating compositions, which have sufficiently long pot lives to allow for manual application, and, which provide elastic coatings having improved mechanical properties.

### SUMMARY OF THE INVENTION

The present invention is directed to a two-component coating system that includes:

(i) a prepolymer containing free isocyanate groups, having an NCO content of from 0.4 to 12% by weight, obtainable by reaction of a di- or polyisocyanate with one or more polyoxyalkylene polyols having an average hydroxy functionality of from 1.96 to 6 and an equivalent weight of at least 250 g/mol, wherein the polyoxyalkylene polyols are obtained by alkoxylating hydroxy-functional starter molecules in the presence of double metal cyanide catalysts, and

(ii) an amino functional polyaspartic ester of the general formula

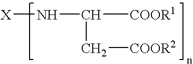

in which

X represents an n-valent organic radical obtained by removing the amino groups from a polyamine selected from the group consisting of ethylenediamine, 1,2-diaminopropane, 1,4-diaminobutane, 1,6-diaminohexane, 2,5-diamino-2,5-dimethylhexane, 2,2,4- and/or 2,4,4,-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 2,4′-and/or 4,4′-diaminodicyclohexylmethane, 3,3′-dimethyl-4,4′-diaminodicyclohexylmethane, 2,4,4′-triamino-5-methyldicyclohexylmethane, and polyether polyamines having aliphatically attached primary amino groups with a molecular weight of from 148 to 6000,

R₁ and R₂ represent identical or different organic radicals which are inert towards isocyanate groups under the reaction conditions, with the proviso that R¹ and R² are ethyl when X represents the radical obtained by removing the amino groups from 2,4,4′-triamino-5-methyldicyclohexylmethane, and

n represents an integer of at least 2.

The present invention is further directed to a coating composition obtained by reacting components (i) and (ii) of the inventing two-component coating system, polyureas prepared thereby, and a process for producing elastic coatings including mixing the components of the two-component coating system, applying the mixture to a substrate, and curing the two-component coating system mixture.

### DETAILED DESCRIPTION OF THE INVENTION

Other than in the operating examples, or where otherwise indicated, all numbers or expressions referring to quantities of ingredients, reaction conditions, etc. used in the specification and claims are to be understood as modified in all instances by the term “about.”

Coating compositions have now been found which have sufficiently long pot lives to allow even manual application, and with which elastic coatings having improved mechanical properties can be produced.

The invention provides two-component coating systems comprising

(i) a prepolymer containing free isocyanate groups, having an NCO content of from 0.4 to 12% by weight, in some cases from 1 to 7% by weight, and in other cases from 1.5 to 4% by weight, obtainable by reacting a di- or polyisocyanate with one or more polyoxyalkylene polyols obtainable by alkoxylating hydroxy-functional starter molecules in the presence of double metal cyanide (DMC) catalysts and having an average hydroxy functionality of from 1.96 to 6 and an equivalent weight of at least 250 g/mol, and

(ii) an amino-functional polyaspartic ester of the general formula

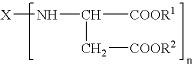

in which

X represents an n-valent organic radical obtained by removing the amino groups from a polyamine selected from the group consisting of ethylenediamine, 1,2-diaminopropane, 1,4-diaminobutane, 1,6-diaminohexane, 2,5-diamino-2,5-dimethylhexane, 2,2,4- and/or 2,4,4,-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 2,4′- and/or 4,4′-diaminodicyclohexylmethane, 3,3′-dimethyl-4,4′-diaminodicyclohexylmethane, 2,4,4′-triamino-5-methyldicyclohexylmethane, and polyether polyamines having aliphatically attached primary amino groups with a molecular weight of from 148 to 6000,

R₁ and R₂ represents identical or different organic radicals which are inert towards isocyanate groups under the reaction conditions, with the proviso that R¹ and R² are ethyl when X represents the radical obtained by removing the amino groups from 2,4,4′-triamino-5-methyldicyclohexylmethane, and

n represents an integer of at least 2.

The isocyanate component (i) is a prepolymer containing isocyanate groups and having an NCO content of from 0.4 to 12% by weight, in some cases from 1 to 7% by weight, and in other cases from 1.5 to 4% by weight, which is obtainable by reacting at least one polyisocyanate with one or more polyoxyalkylene polyols which are obtainable by alkoxylating hydroxy-functional starter compounds with one or more alkylene oxides, non-limiting examples being propylene oxide and mixtures of propylene oxide and ethylene oxide, in the presence of DMC catalysts and which have an average hydroxy functionality of from 1.96 to 6, in some cases from 1.96 to 3, and an equivalent weight of at least 250 g/mol or a number-average molecular weight of from 500 to 20 000, in some cases from 1000 to 8000, and in other cases from 2000 to 6000 g/mol.

Suitable DMC catalysts for the polyaddition reaction of alkylene oxides with starter compounds containing active hydrogen atoms are known. In many cases, in the polyoxyalkylene polyols for preparing the prepolymers (i) of the invention DMC catalysts based on zinc hexacyanocobaltate are used, especially those additionally containing tert-butanol as an organic complex ligand (alone or in combination with a polyether), as disclosed by EP-A 700 949, EP-A 761 708 and WO 97/40086. With these catalysts it is possible to obtain polyoxyalkylene polyols which in comparison to polyols prepared with alkali metal hydroxide catalysts contain a reduced fraction of monofunctional polyethers having terminal double bonds, known as monools. The polyoxyalkylene polyols for use in accordance with the invention typically have double bond contents of less than 50 mmol/kg, in some cases less than 20 mmol/kg and in other cases less than 10 mmol/kg.

Suitable polyisocyanates include, but are not limited to aromatic, aliphatic and cycloaliphatic polyisocyanates. Non-limiting examples of suitable polyisocyanates are compounds of the formula Q(NCO)ₙ having a number-average molecular weight of less than 800 g/mol, in which n is a number from 2 to 4 and Q is an aromatic C₆-C₁₅ hydrocarbon radical, an aliphatic C₄-C₁₂ hydrocarbon radical or a cycloaliphatic C₆-C₁₅ hydrocarbon radical. Non-limiting examples are diisocyanates such as toluene diisocyanate (TDI), methylenediphenyl diisocyanate (MDI), triisocyanatononane (TIN), naphthyl diisocyanate (NDI), 4,4′-diisocyanatodicyclohexylmethane, 3-isocynatomethyl-3,3,5-trimethylcyclohexyl isocyanate (isophorone diisocyanate=IPDI), tetramethylene diisocyanate, hexamethylene diisocyanate (HDI), 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3′-dimethyldicyclohexylmethane, 4,4′-diisocyanato-2,2-dicyclohexylpropane, 3-isocyanatomethyl-1-methyl-1-isocyanatocyclohexane (MCI), 1,3-diisooctylcyanato-4-methylcyclohexane, 1,3-diisocyanato-2-methylcyclohexane and α,α,α′,α′-tetramethyl-m-xylylene diisocyanate or α,α,α′α′-tetramethyl-p-xylylene diisocyanate (TMXDI) and also mixtures consisting of these compounds.

In many cases the polyisocyanates include cycloaliphatic or aromatic diisocyanates, particularly isocyanatomethyl-3,3,5-trimethylcyclohexyl isocyanate (IPDI), toluene 2,4-diisocyanate and toluene 2,6-diisocyanate (TDI) and methylenediphenyl diisocyanate (MDI), and also mixtures of these compounds.

To prepare the NCO prepolymers the polyisocyanate and the polyoxyalkylene polyol or mixtures thereof are reacted to form urethane while observing an NCO/OH equivalents ratio of from 1.5:1 to 10:1. The reaction takes place at temperatures from 40 to 140° C., in some cases from 50 to 110° C. If a polyisocyanate excess of more than 2:1 is used excess monomeric polyisocyanate is removed after the reaction by means of distillative or extractive techniques which are customary in the art (e.g. thin-film distillation).

The reaction can be accelerated by using a catalyst which accelerates the formation of urethane. Common catalysts include, but are not limited to, organometallic compounds, amines (e.g. tertiary amines) or metal compounds such as lead octoate, mercury succinate, tin octoate or dibutyltin dilaurate. In many cases the catalysts are used at from 0.001 to 5% by weight, in some cases from 0.002 to 2% by weight, of catalyst or catalyst combination, based on the overall weight of the prepolymer batch.

In an embodiment of the invention, the curing components (ii) are those amino-functional polyaspartic esters of the general formula

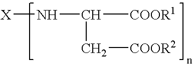

in which X represents a divalent hydrocarbon radical which is obtained by removing the amino groups from 1,4-diaminobutane, 1,6-diaminohexane, 2,2,4-and/or 2,4,4-trimethyl-1,6-diaminohexane, 1-amino-3,3,5-trimethyl-5-aminomethylcyclohexane, 4,4′-diaminodicyclohexylmethane or 3,3′-dimethyl-4,4′-diaminodicyclohexylmethane, and n represents 2. In a particular embodiment, the compounds are those in which R₁ and R₂ represent methyl or ethyl radicals.

The amino-functional polyaspartic esters (ii) are prepared in a manner known per se by reaction of the corresponding primary polyamines of the formula

X[NH₂]ₙ

with maleic or fumaric esters of the general formula

R¹OOC—CH═CH—COOR²

Suitable polyamines are the diamines mentioned above. Examples of suitable maleic or fumaric esters are dimethyl maleate, diethyl maleate, dibutyl maleate, and the corresponding fumarates.

The preparation of the amino-functional polyaspartic esters (ii) from the stated starting materials takes place in many cases within the temperature range from 0 to 100° C., the starting materials being used in proportions such that for each primary amino group there is at least one, in many cases exactly one, olefinic double bond; following the reaction it is possible to separate off any starting materials employed in excess by distillation. The reaction can take place without solvent or in the presence of suitable solvents such as methanol, ethanol, propanol or dioxane or mixtures of such solvents.

The invention also provides coating compositions obtainable by reacting components (i) and (ii), these components being used in amounts such that the equivalents ratio of the isocyanate groups of component (i) to the amino groups of component (ii) is from 0.5:1 to 1.5:1, in some cases from 0.9:1 to 1.5:1.

In order to prepare the coating compositions of the invention the individual components and any auxiliaries and additives that are to be used as well are mixed with one another. The reaction mixtures react to give polyureas even at room temperature and consequently have only a limited pot life. The reaction mixtures must be processed within this pot life. The coating compositions of the invention have a pot life at 23° C. of from 45 to 150 minutes, in some cases from 60 to 120 minutes, the pot life being defined as the period of time within which the coating can be applied homogeneously without forming strings.

Non-limiting examples of auxiliaries and additives that may be intended for use during the preparation of the coating compositions of the invention are pigments, fillers, plasticizers such as coal tar, or levelling assistants.

The two-component binders of the invention are particularly suitable for producing elastic coatings. The coating compositions obtainable from the binders of the invention can be applied to any desired substrates by methods which are known per se, for example by spraying, brushing, flow coating or with the aid of rollers or doctor blades. Examples of suitable substrates include metal, wood, glass, stone, ceramic materials, concrete, hard and flexible plastics, textiles, leather or paper. From the coating compositions of the invention it is possible to obtain coatings having outstanding mechanical properties, with a hardness of at least 10 Shore A and an elongation at break of at least 300%.

### EXAMPLES

Examples 1-3 describe the preparation of typical prepolymers.

### Example 1

174 g (2 eq) of toluene 2,4-diisocyanate (Desmodurg® T00, Bayer AG) were introduced under nitrogen at 50° C. A mixture of 1800 g (0.9 eq) of a polyoxypropylene glycol having a number-average molecular weight of 4000 g/mol (Acclaim® 4200, Bayer AG) and 100 g (0.1 eq) of a polyoxypropylene glycol having a number-average molecular weight of 2000 g/mol (Acclaim® 2200, Bayer AG) was slowly added dropwise at a rate such that the temperature did not exceed 70° C. After 28 hours of stirring at a reaction temperature of between 60 and 70° C. the theoretically calculated NCO content of 2.03% by weight had been reached. The reaction was ended and the product cooled to room temperature.

The NCO prepolymer obtained had an NCO content of 2.00% by weight and a viscosity of 6500 mPa·s at 23° C.

### Example 2

250 g (2 eq) of a mixture of 65% 2,4′-diphenylmethane diisocyanate and 35% 4,4′-diphenylmethane diisocyanate (Desmodur® PU1806) were introduced under nitrogen at 60° C. A mixture of 1200 g (0.6 eq) of a polyoxypropylene glycol having a number-average molecular weight of 4000 g/mol (Acclaim® 4200, Bayer AG) and 400 g (0.4 eq) of a polyoxypropylene glycol having a number-average molecular weight of 2000 g/mol (Acclaim® 2200, Bayer AG) was slowly added dropwise at a rate such that the temperature did not exceed 70° C. After 12 hours of stirring at a reaction temperature of between 60 and 70° C. the theoretically calculated NCO content of 2.27% by weight had been reached. The reaction was ended and the product cooled to room temperature.

The NCO prepolymer obtained had an NCO content of 2.20% by weight and a viscosity of 25 000 mPa·s at 23° C.

### Example 3

222 g (2 eq) of 1-isocyanato-3-isocyanatomethyl-3,5,5-trimethylcyclohexane (Desmodur® I, Bayer AG) were introduced under nitrogen at 60° C. A mixture of 1400 g (0.7 eq) of a polyoxypropylene glycol having a number-average molecular weight of 4000 g/mol (Acclaim® 4200, Bayer AG) and 600 g (0.3 eq) of a polyoxypropylene glycol prepared starting from glycerol and having a number-average molecular weight of 6000 g/mol (Acclaim® 6300, Bayer AG) was slowly added dropwise at a rate such that the temperature did not exceed 70° C. Following the dropwise addition 0.0022 g (25 ppm) of dibutyltin laureate (DBTL) was added. During the reaction the temperature did not exceed 70° C. After 6 hours of stirring at a reaction temperature of between 60 and 70° C. the theoretically calculated NCO content of 2.89% by weight had been reached. The reaction was ended and the product cooled to room temperature.

The NCO prepolymer obtained had an NCO content of 1.80% by weight and a viscosity of 17 000 mPa·s at 23° C.

### Example 4

### Preparation of an Amino-Functional Polyaspartic Ester

344 g (2 mol) of diethyl maleate were added dropwise at 50° C. with stirring to 210 g (2 eq) of 4,4′-diaminodicyclohexylmethane. When addition was complete the mixture was stirred at 60° C. for 90 h under an N₂ atmosphere with dewatering during the last two hours at approximately 1 mbar. This gave a liquid product having an equivalent weight of 277 g/mol.

The following example describes the production of coatings and their mechanical properties.

### Example 5

Prepolymers prepared in analogy to Examples 1-3 were cured at room temperature with the amino-functional polyaspartic ester prepared in Example 4, observing an NCO/NH₂ ratio of 1.05:1 and 1.2:1 respectively. Table 1 compiles the pot lives and the mechanical properties of the coatings obtained. The Shore A hardness was determined in accordance with DIN 53505, tensile strength and elongation at break in accordance with DIN/ISO 527, tear propagation resistance in accordance with DIN 53515.

TABLE 1

| | | | | | | | Tear | |
|---|---|---|---|---|---|---|---|---|
| | | | | | | Elon- | propa- | |
| | | NCO | | | | gation | gation | Hard- |
| | | content | NCO/ | Pot | Tensile | at | resist- | ness |
| Isocy- | Polyether* | [% by | NH | life | strength | break | ance | [Shore |
| anate | (Acclaim) | wt.] | ratio | [min] | [N/mm²] | [%] | [N/mm] | A] |
| MDI | 2200/4200 = | 2.2 | 1.05 | 60 | >10 | >1800 | 8.2 | 27 |
| | 4/6 | | | | | | | |
| MDI | 2200/4200 = | 2.2 | 1.2 | 60 | 5.4 | 1270 | 8.6 | 35 |
| | 4/6 | | | | | | | |
| MDI | 4200/6300 = | 1.84 | 1.05 | 60 | >2.5 | >1500 | 5.1 | 14 |
| | 8/2 | | | | | | | |
| MDI | 4200/6300 = | 1.84 | 1.2 | 60 | 2.5 | 708 | 6.1 | 31 |
| | 8/2 | | | | | | | |
| MDI | 2200/6300 = | 1.83 | 1.05 | 60 | 3.6 | 737 | 5.7 | 31 |
| | 7/3 | | | | | | | |
| MDI | 2200/6300 = | 1.83 | 1.2 | 60 | 2.8 | 516 | 6.2 | 38 |
| | 7/3 | | | | | | | |
| TDI | 2200/4200 = | 2.0 | 1.05 | 70 | — | — | — | 15 |
| | 1/9 | | | | | | | |
| TDI | 2200/4200 = | 2.0 | 1.2 | 70 | — | — | — | 15 |
| | 1/9 | | | | | | | |
| IPDI | 4200/6300 = | 1.8 | 1.05 | 120 | — | — | — | 25 |
| | 7/3 | | | | | | | |
| IPDI | 4200/6300 = | 1.8 | 1.2 | 120 | — | — | — | 26 |
| | 7/3 | | | | | | | |
| IPDI | 4200/6300 = | 1.9 | 1.05 | 120 | — | — | — | 28 |
| | 6/4 | | | | | | | |
| IPDI | 4200/6300 = | 1.9 | 1.2 | 120 | — | — | — | 27 |
| | 6/4 | | | | | | | |
| IPDI | 4200/6300 = | 1.8 | 1.05 | 120 | — | — | — | 30 |
| | 5/5 | | | | | | | |
| IPDI | 4200/6300 = | 1.8 | 1.2 | 120 | — | — | — | 31 |
| | 5/5 | | | | | | | |

*Ratio of the polyethers in the mixture based on equivalent weight

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A two-component coating system comprising
(i) a prepolymer containing free isocyanate groups, having an NCO content of from 0.4 to 12% by weight, obtainable by reaction of a di- or polyisocyanate with one or more polyoxyalkylene polyols having an average hydroxy functionality of from 1.96 to 6 and an equivalent weight of at least 250 g/mol, wherein the polyoxyalkylene polyols are obtained by alkoxylating hydroxy-functional starter molecules in the presence of double metal cyanide catalysts, and
(ii) an amino-functional polyaspartic ester of the general formula 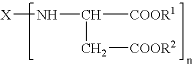
in which
X represents an n-valent organic radical obtained by removing the amino groups from a polyamine selected from the group consisting of ethylenediamine, 1,2-diaminopropane, 1,4-diaminobutane, 1,6-diaminohexane, 2,5-diamino-2,5-dimethylhexane, 2,2,4- and/or 2,4,4,-trimethyl-1,6-diaminohexane, 1,11-diaminoundecane, 1,12-diaminododecane, 1-amino-3,3,5-trimethyl-5-aminomethylcyclohexane, 2,4- and/or 2,6-hexahydrotolylenediamine, 2,4′-and/or 4,4′-diaminodicyclohexylmethane, 3,3′-dimethyl-4,4′-diaminodicyclohexylmethane, 2,4,4′-triamino-5-methyldicyclohexylmethane, and polyether polyamines having aliphatically attached primary amino groups with a molecular weight of from 148 to 6000,
R₁ and R₂ represent identical or different organic radicals which are inert towards isocyanate groups under the reaction conditions, with the proviso that R¹ and R² are ethyl when X represents the radical obtained by removing the amino groups from 2,4,4′-triamino-5-methyldicyclohexylmethane, and
n represents an integer of at least 2.

2. The coating system of claim 1, wherein the polyisocyanate of (i) is one or more selected from the group consisting of toluene diisocyanate (TDI), methylenediphenyl diisocyanate (MDI), triisocyanatononane (TIN), naphthyl diisocyanate (NDI), 4,4′-diisocyanatodicyclohexylmethane, 3-isocyanatomethyl-3,3,5-trimethylcyclohexyl isocyanate (isophorone diisocyanate=IPDI), tetramethylene diisocyanate, hexamethylene diisocyanate (HDI), 2-methylpentamethylene diisocyanate, 2,2,4-trimethylhexamethylene diisocyanate (THDI), dodecamethylene diisocyanate, 1,4-diisocyanatocyclohexane, 4,4′-diisocyanato-3,3′-dimethyldicyclohexylmethane, 4,4′-diisocyanato-2,2-dicyclohexylpropane, 3-isocyanatomethyl-1-methyl-1-isocyanatocyclohexane (MCI), 1,3-diisooctylcyanato-4-methylcyclohexane, 1,3-diisocyanato-2-methylcyclohexane and α,α,α′,α′-tetramethyl-m-xylylene diisocyanate or α,α,α′α′-tetramethyl-p-xylylene diisocyanate (TMXDI) and mixtures thereof.

3. The coating system of claim 1, wherein the polyoxyalkylene polyols in (i) have a double bond content of less than 50 mmol/kg.

4. The coating system of claim 1, wherein the amino-functional polyaspartic esters (ii) are prepared by reacting a primary polyamine of the formula
X[NH₂]ₙ
with a maleic ester or a fumaric ester of the formula
R¹OOC—CH═CH—COOR²
wherein R₁, R₂, X and n are as defined in claim 1.

5. A coating composition obtainable by reacting components (i) and (ii) of the two-component coating system according to claim 1 in a proportion corresponding to an NCO/NH₂ equivalents ratio of from 0.5:1 to 1.5:1.

6. A coating composition according to claim 5, comprising one or more additives selected from the group consisting of pigments, fillers, plasticizers such as coal tar, and levelling assistants.

7. A process for producing elastic coatings comprising, mixing the components of the two-component coating system according to claim 1 in a proportion corresponding to an NCO/NH₂ equivalents ratio of from 0.5:1 to 1.5:1; and applying the mixture to a substrate; and curing the two-component coating system mixture.

8. A polyurea polymer prepared by reacting the coating composition according to claim 2.
